(19) United States
(12) Patent Application Publication
(10) Pub. No.: US 2013/0307665 A1
(43) Pub. Date: Nov. 21, 2013

(54) CONTROL SYSTEM FOR CONTROLLING ACCESSORIES OF MOBILE DEVICE

(71) Applicants: Chih-Li Wang, New Taipei City (TW); Chien-Yuan Hsiao, New Taipei City (TW); Jui-Lin Hsiao, New Taipei City (TW)

(72) Inventors: Chih-Li Wang, New Taipei City (TW); Chien-Yuan Hsiao, New Taipei City (TW); Jui-Lin Hsiao, New Taipei City (TW)

(73) Assignee: WISTRON CORP., New Taipei City (TW)

(21) Appl. No.: 13/591,170

(22) Filed: Aug. 21, 2012

(30) Foreign Application Priority Data
May 21, 2012 (TW) TW101117974

(51) Int. Cl. G05B 19/00; H02J 17/00; H02J 7/00

(52) U.S. Cl. 340/5.1; 320/108

(57) ABSTRACT

A control system includes a wireless dock, a mobile device, and one or more accessories. The one or more accessories are used with the mobile device. When the mobile device is close to the wireless dock, the mobile device receives a message from the wireless dock, and the mobile device obtains environmental information according to the message so as to control operating states of the accessories.

### CROSS REFERENCE TO RELATED APPLICATIONS

This Application claims priority of Taiwan Patent Application No. 101117974 filed on May 21, 2012, the entirety of which is incorporated by reference herein.

### BACKGROUND OF THE INVENTION

1. Field of the Invention

The disclosure generally relates to a control system, and more particularly, relates to a control system for wirelessly controlling accessories of a mobile device.

2. Description of the Related Art

Traditionally, a mobile device is connected through at least one wire to an expansion dock, such as a charging dock. When operating the mobile device and the expansion dock, a user often needs to insert and pull a plurality of connection wires therebetween. This is very inconvenient for the user. In addition, accessories of the mobile device are required to be controlled manually, and it takes the user a lot of time.

Accordingly, there is a need to design a new control system capable of wirelessly controlling a variety of accessories of the mobile device.

### BRIEF SUMMARY OF THE INVENTION

In one exemplary embodiment, the disclosure is directed to a control system, comprising: a wireless dock; a mobile device; and one or more accessories, used with the mobile device, wherein when the mobile device is close to the wireless dock, the mobile device receives a message from the wireless dock, and the mobile device obtains environmental information according to the message so as to control operating states of the accessories.

### BRIEF DESCRIPTION OF DRAWINGS

The invention can be more fully understood by reading the subsequent detailed description and examples with references made to the accompanying drawings, wherein:

FIG. 1 is a diagram for illustrating a control system according to an embodiment of the invention;

FIG. 2 is a diagram for illustrating a wireless dock and a mobile device according to an embodiment of the invention;

FIGS. 3A and 3B are a flowchart for illustrating the operation of the control system according to an embodiment of the invention;

FIG. 4A is a diagram for illustrating the operation of the control system in a step of FIG. 3 according to an embodiment of the invention;

FIG. 4B is a diagram for illustrating the operation of the control system in a step of FIG. 3 according to an embodiment of the invention; and

FIG. 4C is a diagram for illustrating the operation of the control system in a step of FIG. 3 according to an embodiment of the invention.

### DETAILED DESCRIPTION OF THE INVENTION

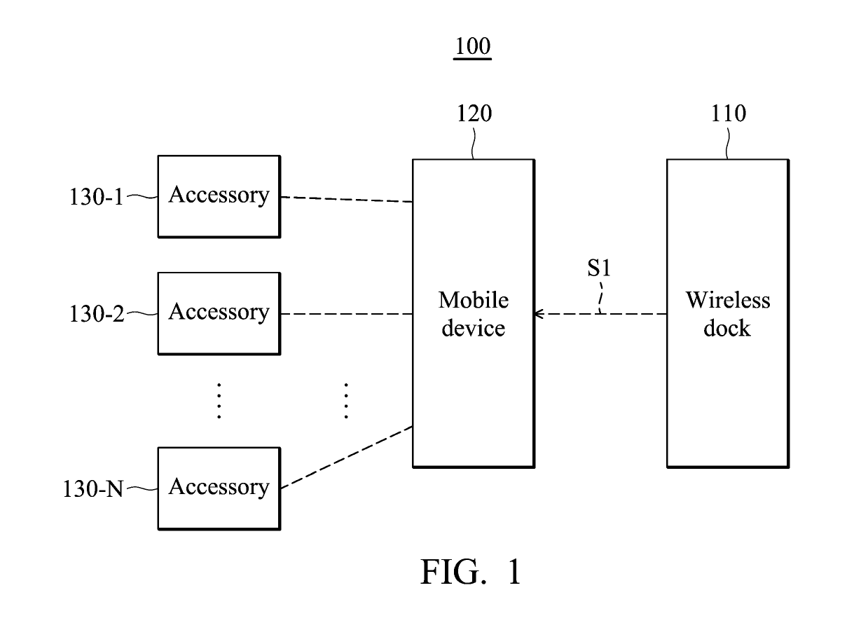

FIG. 1 is a diagram for illustrating a control system 100 according to an embodiment of the invention. As shown in FIG. 1, the control system 100 comprises a wireless dock 110, a mobile device 120, and one or more accessories 130-1, 130-2, . . . , and 130-N, wherein N is a positive integer. The mobile device 120 may be a mobile phone, a tablet computer, or a notebook computer. The accessories 130-1, 130-2, . . . , and 130-N are used with the mobile device 120, and the relationship comprises wired connection, wireless connection, and other connections. The accessories 130-1, 130-2, . . . , and 130-N may comprise a wireless display device, a wireless mouse, and/or a wireless keyboard, etc. The accessories 130-1, 130-2, . . . , and 130-N will be illustrated in detail later. When the mobile device 120 is close to the wireless dock 110 (e.g., the distance between the mobile device 120 and the wireless dock 110 is smaller than a predetermined distance), the mobile device 120 receives a message S1 from the wireless dock 110, and then the mobile device 120 obtains environmental information according to the message S1 so as to control operating states of the accessories 130-1, 130-2, . . . , and 130-N. For example, the mobile device 120 may turn on or turn off the accessories 130-1, 130-2, . . . , and 130-N. If the mobile device 120 communicates with the accessories 130-1, 130-2, . . . , and 130-N through wireless connection, the wireless connection may be selected among Bluetooth communication, infrared communication, RFID (Radio Frequency Identification) communication, UWB (Ultra-Wide Band) communication, and NFC (Near Field Communication). In a preferred embodiment, the environmental information indicates an environment where the wireless dock 110 is located, such as an office, a home, or a car.

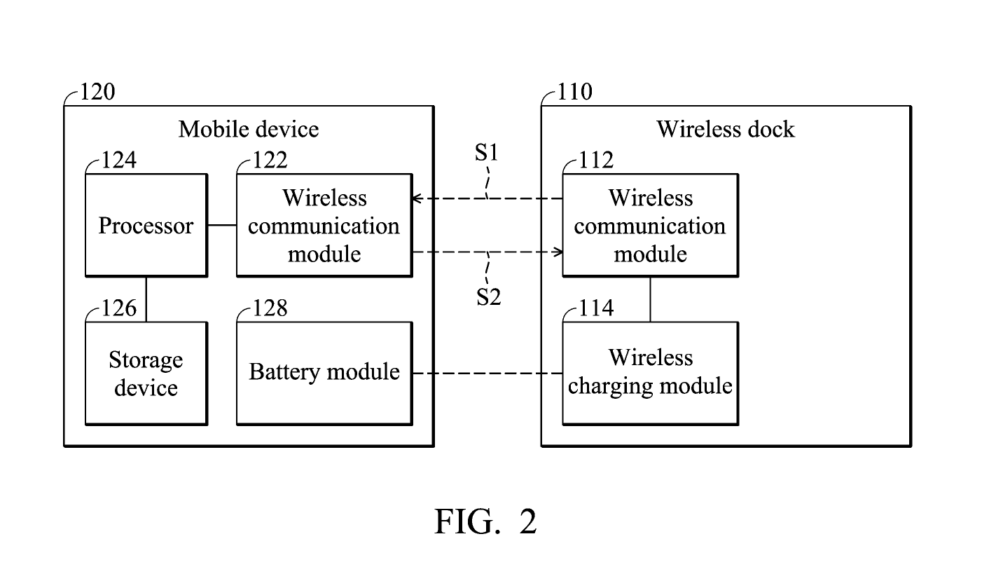

FIG. 2 is a diagram for illustrating the wireless dock 110 and the mobile device 120 according to an embodiment of the invention. As shown in FIG. 2, the wireless dock 110 comprises a wireless communication module 112 and a wireless charging module 114, and the mobile device 120 comprises a wireless communication module 122, a processor 124, a storage device 126, and a battery module 128. In some embodiments, the wireless communication module 112 of the wireless dock 110 comprises an RFID tag, and the wireless communication module 122 of the mobile device 120 comprises an RFID reader. The message S1, which is transmitted by the wireless dock 110, may comprise an identification code stored in the wireless dock 110. For example, the identification code is stored in the RFID tag.

In an embodiment, the storage device 126 is configured to store a table, which records different environmental information corresponding to all kinds of identification codes. When the mobile device 120 is close to the wireless dock 110, the mobile device 120 communicates with the wireless dock 110 through the wireless communication modules 122 and 112. The processor 124 of the mobile device 120 looks up the table according to the received message S1 so as to obtain the environmental information. A user may edit the content of the table through an application program stored in the mobile device 120.

In a preferred embodiment, when the mobile device 120 is close to the wireless dock 110, the wireless charging module 114 of the wireless dock 110 wirelessly charges the battery module 128 of the mobile device 120. The wireless dock 110 is coupled to a fixed power source. The mobile device 120 may further transmit a notification signal S2 to the wireless dock 110, and the wireless charging module 114 of the wireless dock 110 may select a charging mode according to the notification signal S2. The notification signal S2 may indicate a brand or a type of the mobile device 120. For example, if the mobile device 120 is a mobile phone, the wireless dock 110 will select low power to charge the mobile device 120. If the mobile device 120 is a tablet computer, the wireless dock 110 will select high power to charge the mobile device 120.

In a preferred embodiment, when the mobile device 120 is close to the wireless dock 110, the mobile device 120 wirelessly turns on some or all of the accessories 130-1, 130-2, . . . , and 130-N according to the environmental information. On the contrary, when the mobile device 120 is away from the wireless dock 110 (e.g., the distance between the mobile device 120 and the wireless dock 110 is greater than a predetermined distance, or the mobile device 120 cannot detect any message S1), the mobile device 120 wirelessly turns off all of the accessories 130-1, 130-2, . . . , and 130-N to save power.

In another embodiment, when the mobile device 120 is close to the wireless dock 110, the mobile device 120 further controls functions of some or all of the accessories 130-1, 130-2, . . . , and 130-N according to the environmental information. For example, the mobile device 120 adjusts the volume of an audio device or the brightness of a display device.

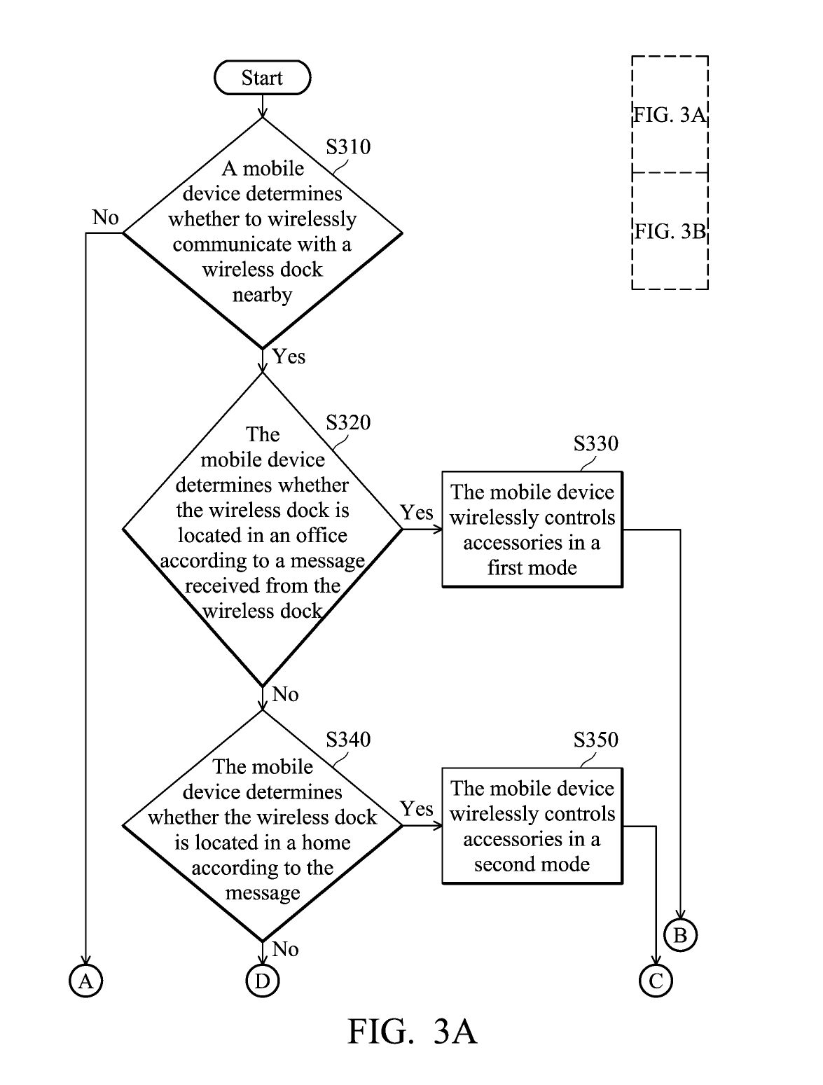

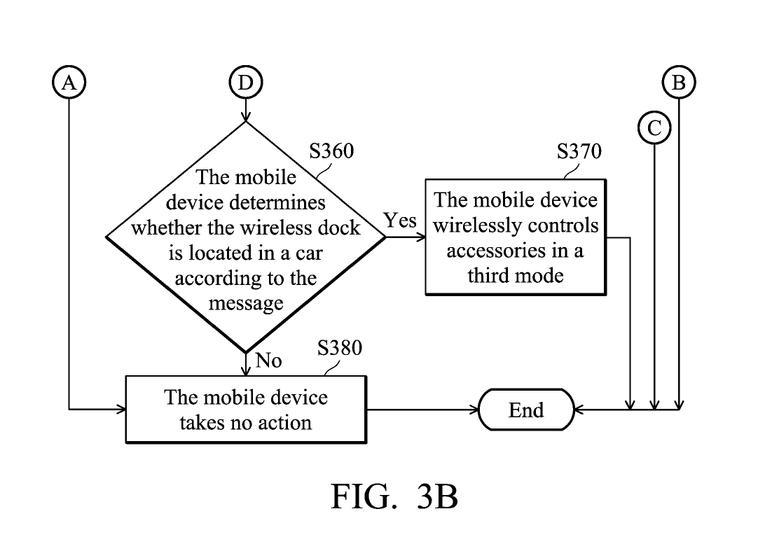

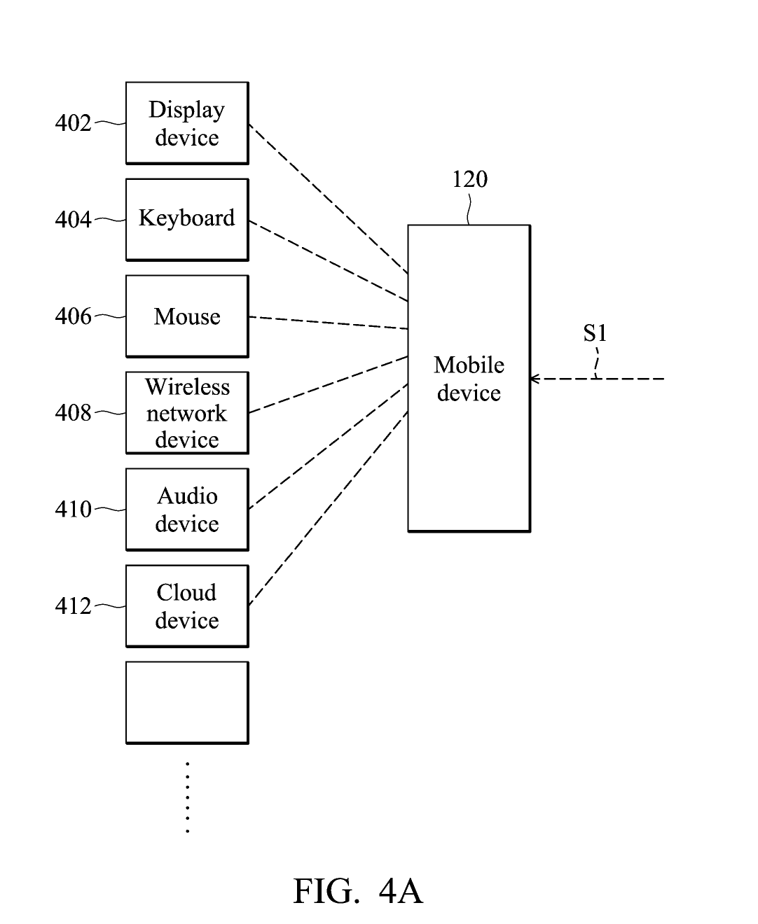

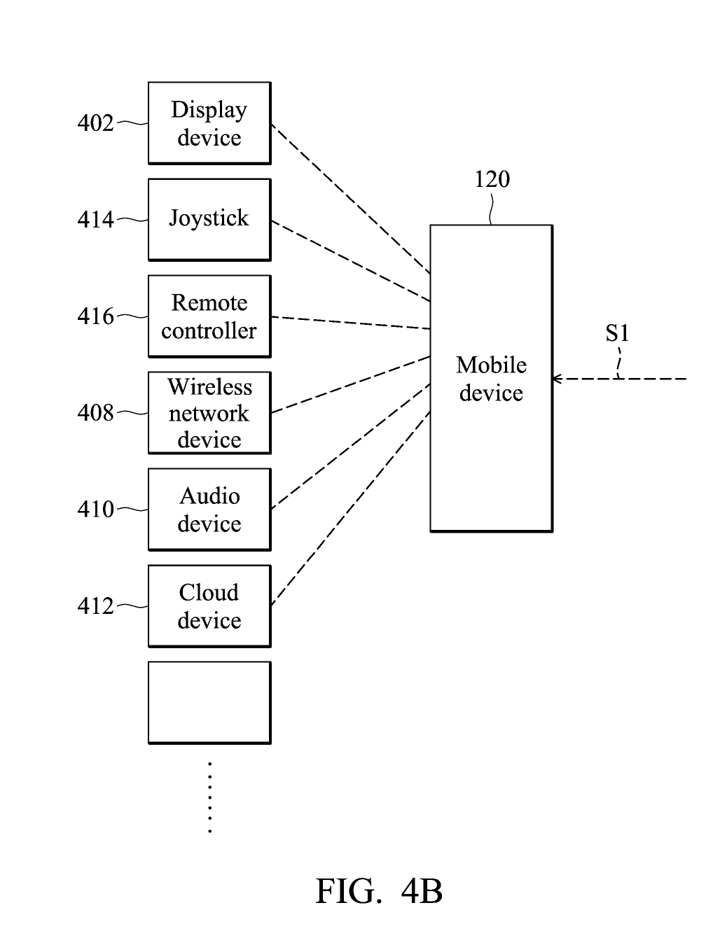

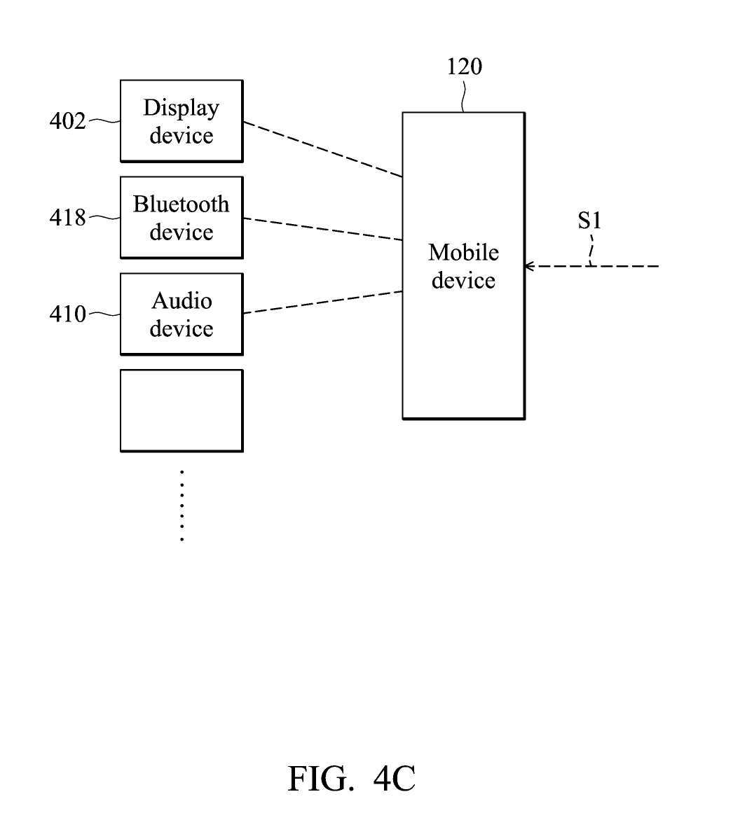

FIGS. 3A and 3B are a flowchart for illustrating the operation of the control system 100 according to an embodiment of the invention. To begin, in step S310, the mobile device 120 determines whether to wirelessly communicate with the wireless dock 110 nearby. If not, in step S380, the mobile device 120 will take no action. The steps end. If so, in step S320, the mobile device 120 will determine whether the wireless dock 110 is located in an office according to the received message 51. Similarly, in steps S340 and S360, the mobile device 120 will determine whether the wireless dock 110 is located in a home and a car according to the received message S1, respectively. If the wireless dock 110 is not located in the office, the home or the car, the procedure will proceed to step S380, and the mobile device 120 will take no action. In steps S330, S350 and S370, if it is determined that the wireless dock 110 is located in the office, the home or the car, respectively, the mobile device 120 will wirelessly control, in different modes, the operating states of the accessories 130-1, 130-2, . . . , and 130-N. Note that steps S320, S340 and 360 are not required to be performed in order, and the operation of the control system 100 may comprise more or less steps for distinguishing the environment. Steps S330, S350 and S370 will be described in detail with reference to FIGS. 4A-4C later.

FIG. 4A is a diagram for illustrating the operation of the control system 100 in step S330 of FIG. 3 according to an embodiment of the invention. In the embodiment, the accessories 130-1, 130-2, . . . , and 130-N comprise a display device 402, a keyboard 404, a mouse 406, a wireless network device 408, an audio device 410, a cloud device 412, and other elements. In a preferred embodiment, the foregoing accessories are all wireless components. If the environmental information indicates that the wireless dock 110 is located in an office, the mobile device 120 will turn on the display device 402, the keyboard 404, the mouse 406, the wireless network device 408, the audio device 410, and the cloud device 412. That is, some of the accessories 130-1, 130-2, . . . , and 130-N for use in the office may be turned on automatically by the mobile device 120, not by a user. Note that the accessories as shown in FIG. 4A are exemplary, and the invention may comprise more or less accessories used in the office.

FIG. 4B is a diagram for illustrating the operation of the control system 100 in step S350 of FIG. 3 according to an embodiment of the invention. In the embodiment, the accessories 130-1, 130-2, . . . , and 130-N comprise a display device 402, a joystick 414, a remote controller 416, a wireless network device 408, an audio device 410, a cloud device 412, and other elements. In a preferred embodiment, the foregoing accessories are all wireless components. If the environmental information indicates that the wireless dock 110 is located in a home, the mobile device 120 will turn on the display device 402, the joystick 414, the remote controller 416, the wireless network device 408, the audio device 410, and the cloud device 412. That is, some of the accessories 130-1, 130-2, . . . , and 130-N for use in the home may be turned on automatically by the mobile device 120, not by a user. Note that the accessories as shown in FIG. 4B are exemplary, and the invention may comprise more or less accessories used in the home.

FIG. 4C is a diagram for illustrating the operation of the control system 100 in step S370 of FIG. 3 according to an embodiment of the invention. In the embodiment, the accessories 130-1, 130-2, . . . , and 130-N comprise a display device 402, a Bluetooth device 418, an audio device 410, and other elements. In a preferred embodiment, the foregoing accessories are all wireless components. If the environmental information indicates that the wireless dock 110 is located in a car, the mobile device 120 will turn on the display device 402, the Bluetooth device 418, and the audio device 410. That is, some of the accessories 130-1, 130-2, . . . , and 130-N for use in the car may be turned on automatically by the mobile device 120, not by a user. Note that the accessories as shown in FIG. 4C are exemplary, and the invention may comprise more or less accessories used in the car.

In the invention, a mobile device recognizes a surrounding environment according to a message provided by a wireless dock, and automatically turns on corresponding accessories without any connection wire. When the mobile device is away from the surrounding environment, the accessories are further turned off automatically by the mobile device in order to save power. The control system of the invention provides a friendly operative interface for users.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. A control system, comprising:
a wireless dock;
a mobile device; and
one or more accessories, used with the mobile device,
wherein when the mobile device is close to the wireless dock, the mobile device receives a message from the wireless dock, and the mobile device obtains a environmental information according to the message so as to control operating states of the accessories.

2. The control system as claimed in claim 1, wherein the mobile device is a mobile phone, a tablet computer, or a notebook computer.

3. The control system as claimed in claim 1, wherein the message comprises an identification code stored in the wireless dock.

4. The control system as claimed in claim 1, wherein the mobile device comprises:
a storage device, storing a table; and
a processor, looking up the table according to the message so as to obtain the environmental information.

5. The control system as claimed in claim 1, wherein the wireless dock comprises:
a wireless charging module, wherein when the mobile device is close to the wireless dock, the wireless charging module wirelessly charges the mobile device.

6. The control system as claimed in claim 5, wherein the mobile device further transmits a notification signal to the wireless dock, and the wireless charging module of the wireless dock selects a charging mode according to the notification signal.

7. The control system as claimed in claim 1, wherein when the mobile device is close to the wireless dock, the mobile device turns on some or all of the accessories according to the environmental information.

8. The control system as claimed in claim 7, wherein if the environmental information indicates that the wireless dock is located in an office, the mobile device turns on a display device, a keyboard, a mouse, a wireless network device, an audio device, or a cloud device of the accessories.

9. The control system as claimed in claim 7, wherein if the environmental information indicates that the wireless dock is located in a home, the mobile device turns on a display device, a joystick, a remote controller, a wireless network device, an audio device, or a cloud device of the accessories.

10. The control system as claimed in claim 7, wherein if the environmental information indicates that the wireless dock is located in a car, the mobile device turns on a display device, a Bluetooth device, or an audio device of the accessories.

11. The control system as claimed in claim 1, wherein when the mobile device is away from the wireless dock, the mobile device turns off all of the accessories.

12. The control system as claimed in claim 1, wherein the mobile device communicates with the accessories through a wireless connection, and the wireless connection is selected among Bluetooth communication, infrared communication, RFID (Radio Frequency Identification) communication, UWB (Ultra-Wide Band) communication, and NFC (Near Field Communication).
